(19) United States
(12) Patent Application Publication
(10) Pub. No.: US 2025/0357614 A1
(43) Pub. Date: Nov. 20, 2025

(54) ELECTRICITY STORAGE APPARATUS

(71) Applicant: Toyota Jidosha Kabushiki Kaisha, Toyota-shi (JP)

(72) Inventors: Kazuki SUGIE, Miyoshi-shi (JP); Akio Mori, Toyota-shi (JP); Yoshiro Kamo, Ashigarakami-gun (JP); Takahiko Nakano, Nagoya-shi (JP); Toshihiro Shimonaka, Toyota-shi (JP); Kenichi Kohashi, Sunto-gun (JP); Yuki Soda, Nagoya-shi (JP)

(73) Assignee: Toyota Jidosha Kabushiki Kaisha, Toyota-shi (JP)

(21) Appl. No.: 19/071,266

(22) Filed: Mar. 5, 2025

(30) Foreign Application Priority Data
May 14, 2024 (JP) 2024-078503

(51) Int. Cl. H01M 50/30; H01M 10/42; H01M 10/613; H01M 10/625; H01M 10/653; H01M 10/6556; H01M 50/249

(52) U.S. Cl. CPC H01M 50/30; H01M 10/425; H01M 10/613; H01M 10/653; H01M 10/6556; H01M 10/625; H01M 50/249

(57) ABSTRACT

An electricity storage apparatus includes an electricity storage module, an adhesive material disposed on an upper face of the electricity storage module, a cooling plate disposed on an upper face of the adhesive material, a case that houses the electricity storage module, the adhesive material, and the cooling plate, and a case gas discharge valve provided on the case. The case gas discharge valve is disposed at a position away from the cooling plate in plan view of the case gas discharge valve and the cooling plate.

### CROSS-REFERENCE TO RELATED APPLICATION

This application claims priority to Japanese Patent Application No. 2024-078503 filed on May 14, 2024, incorporated herein by reference in its entirety.

### BACKGROUND

### 1. Technical Field

The present disclosure relates to an electricity storage apparatus.

### 2. Description of Related Art

Japanese Unexamined Patent Application Publication No. 2021-111520 (JP 2021-111520 A) discloses a battery pack (electricity storage apparatus) including a plurality of battery cells (electricity storage cells), a battery pack case (case), a tray, and a cooler (cooling plate). In the battery pack disclosed in JP 2021-111520 A, the tray is disposed on the battery cells, and the cooler is disposed on the tray.

### SUMMARY

Typically, the case is provided with a case gas discharge valve that discharges gas generated inside the case. Depending on the position at which the case gas discharge valve is provided, the cooler may obstruct the discharge of gas generated inside the case to the outside of the case.

It is an object of the present disclosure to provide an electricity storage apparatus that can easily discharge gas generated inside a case to the outside of the case.

An electricity storage apparatus according to an aspect of the present disclosure includes an electricity storage module, an adhesive material disposed on an upper face of the electricity storage module, a cooling plate disposed on an upper face of the adhesive material, a case that houses the electricity storage module, the adhesive material, and the cooling plate, and a case gas discharge valve provided on the case. The case gas discharge valve is disposed at a position away from the cooling plate in plan view of the case gas discharge valve and the cooling plate.

The electricity storage apparatus may further include a first junction box spaced apart from the electricity storage module in a first direction. The electricity storage apparatus may further include a second junction box spaced apart from the electricity storage module in the first direction, the second junction box being adjacent to the first junction box in a second direction intersecting both the first direction and an up-down direction. The case may include an upper cover, and a lower case. The electricity storage apparatus may have a space in which the first junction box and the second junction box are disposed. The case gas discharge valve may be provided on the upper cover over the space.

The space may include an inter-box region located between the first junction box and the second junction box. The case gas discharge valve may be provided over the inter-box region.

The present disclosure makes it possible to easily discharge gas generated inside the case to the outside of the case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view schematically showing a vehicle including an electricity storage apparatus in an embodiment of the present disclosure;

FIG. 2 is an exploded perspective view of the electricity storage apparatus shown in FIG. 1;

FIG. 3 is a perspective view schematically showing an electricity storage cell shown in FIG. 2;

FIG. 4 is a plan view schematically showing the electricity storage apparatus shown in FIG. 2;

FIG. 5 is a plan view schematically showing the electricity storage apparatus shown in FIG. 2 with an upper cover removed;

FIG. 6 is a sectional view taken along line VI-VI in FIG. 4; and

FIG. 7 is a sectional view taken along line VII-VII in FIG. 4.

### DETAILED DESCRIPTION OF EMBODIMENTS

Hereinbelow, an embodiment and a modification according to the present disclosure will be described with reference to the drawings. In the following description, identical components and constituent elements are designated by the same reference signs. These components and constituent elements also have the same names and functions. Thus, detailed description of these components and constituent elements will not be repeated. The embodiment and the modification described below may be selectively combined as appropriate.

### Embodiment

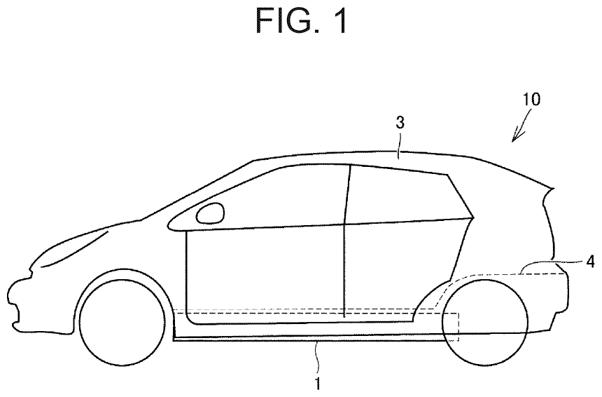

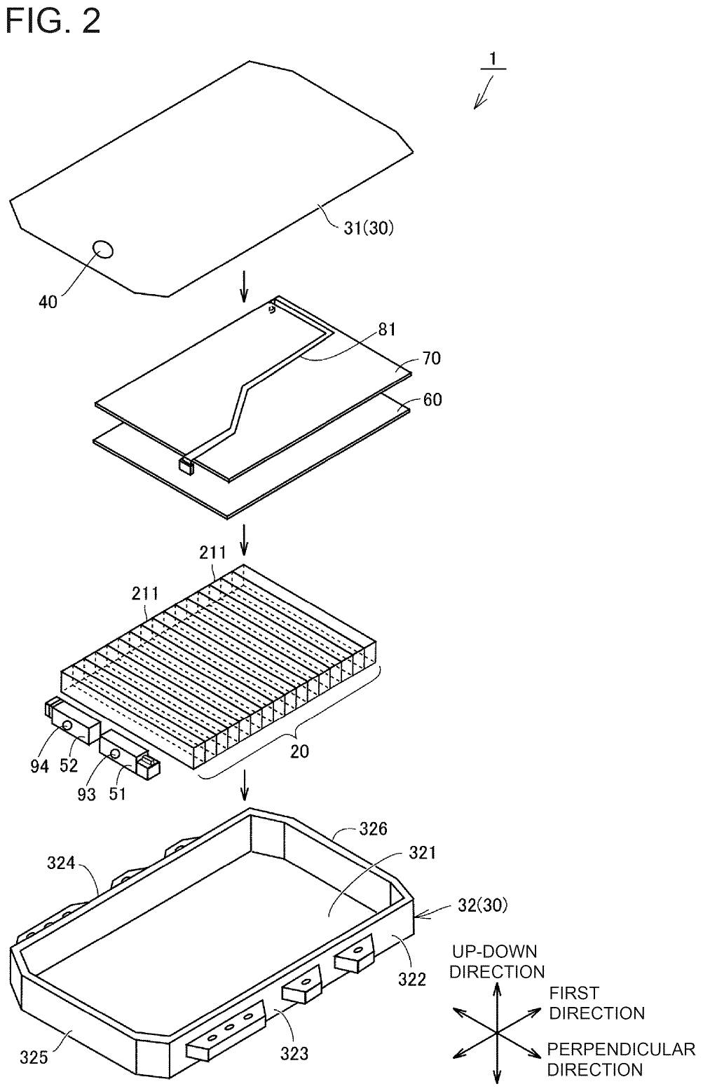

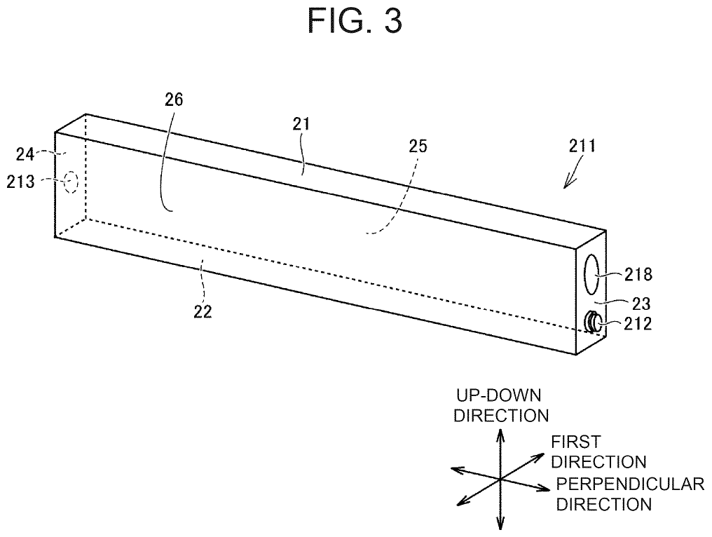

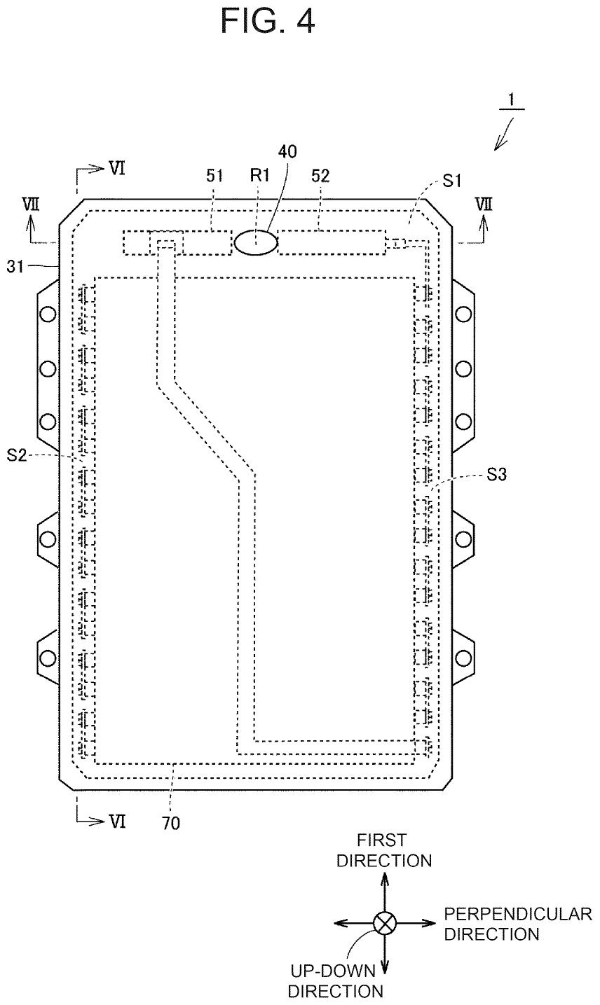

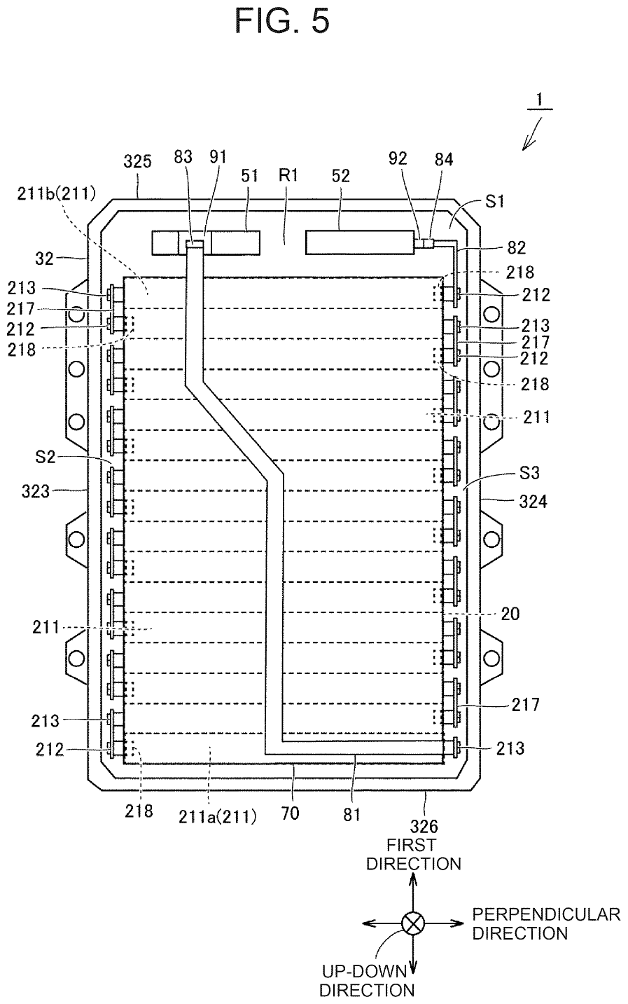

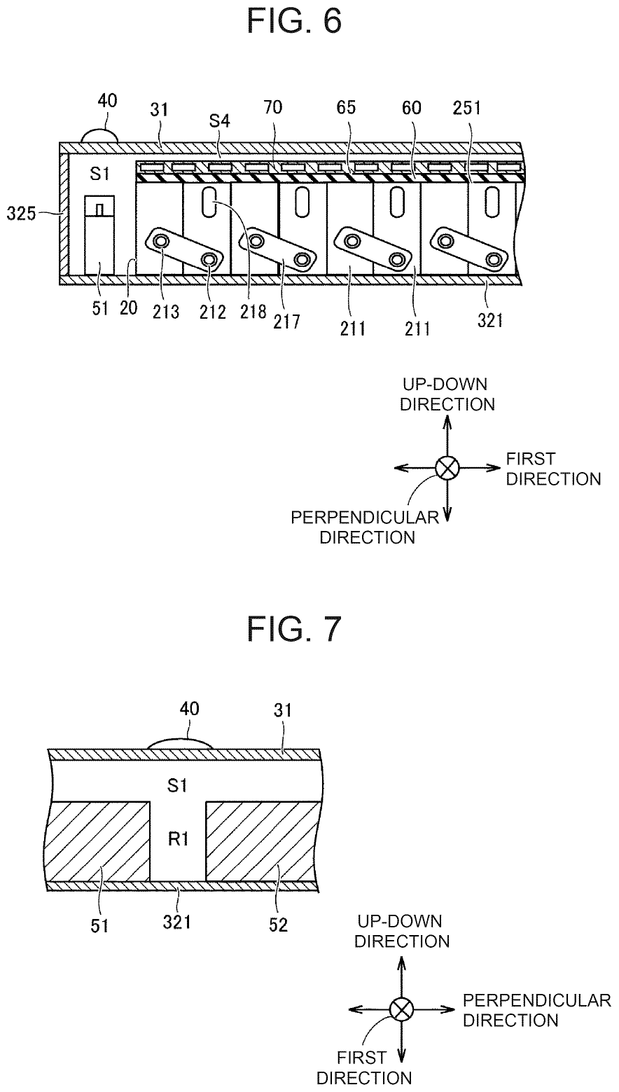

An electricity storage apparatus in an embodiment of the present disclosure will be described with reference to FIGS. 1 to 7. FIG. 1 is a side view schematically showing a vehicle including the electricity storage apparatus in the embodiment of the present disclosure. FIG. 2 is an exploded perspective view of the electricity storage apparatus shown in FIG. 1. FIG. 3 is a perspective view schematically showing an electricity storage cell shown in FIG. 2. FIG. 4 is a plan view schematically showing the electricity storage apparatus shown in FIG. 2. FIG. 5 is a plan view schematically showing the electricity storage apparatus shown in FIG. 2 with an upper cover removed. FIG. 6 is a sectional view taken along line VI-VI in FIG. 4. FIG. 7 is a sectional view taken along line VII-VII in FIG. 4.

Referring to FIG. 1, a vehicle 10 includes an electricity storage apparatus 1, a vehicle frame 3, and a floor panel 4. The electricity storage apparatus 1 is disposed under the floor panel 4. Examples of the vehicle 10 include a hybrid electric vehicle, a plug-in hybrid electric vehicle, a fuel cell electric vehicle, and a battery electric vehicle.

Referring to FIG. 2, the electricity storage apparatus 1 includes an electricity storage module 20, a case 30, a case gas discharge valve 40, a first junction box 51, a second junction box 52, an adhesive material 60, a cooling plate 70, a main bus bar 81, a sub bus bar 82 (refer to FIG. 5), and inter-cell bus bars 217 (refer to FIG. 5).

The electricity storage module 20 includes a plurality of electricity storage cells 211. The electricity storage cells 211 are arranged in a first direction. In the present embodiment, the first direction corresponds to the front-rear direction of the vehicle 10 (refer to FIG. 1). However, the first direction does not have to be the front-rear direction of the vehicle 10. The first direction may be a direction intersecting both the front-rear direction of the vehicle 10 and the up-down direction of the electricity storage apparatus 1. For example, the first direction may be the width direction of the vehicle 10.

In the present embodiment, the electricity storage cells 211 include 16 electricity storage cells 211. However, the number of electricity storage cells 211 is not limited to 16. It is only required that the number of electricity storage cells 211 be one or more. Each electricity storage cell 211 is, for example, a lithium-ion battery. Each electricity storage cell 211 may be an all-solid-state battery with a solid electrolyte.

Referring to FIG. 3, the electricity storage cell 211 has a rectangular parallelepiped shape that is long in a direction perpendicular to both the first direction and the up-down direction of the electricity storage apparatus 1. In the following description, the direction perpendicular to both the first direction and the up-down direction of the electricity storage apparatus 1 is also referred to as the “perpendicular direction”.

The electricity storage cell 211 has an upper face 21, a lower face 22, a pair of short-side faces 23, 24, and a pair of long-side faces 25, 26. The short-side faces 23, 24 are spaced apart from each other in the perpendicular direction. The long-side faces 25, 26 are spaced apart from each other in the first direction. Each of the long-side faces 25, 26 extends in the perpendicular direction.

The electricity storage cell 211 includes a positive electrode terminal 213 and a negative electrode terminal 212. The positive electrode terminal 213 is provided on one of the short-side faces 23, 24, and the negative electrode terminal 212 is provided on the other one of the short-side faces 23, 24. In the example shown in FIG. 3, the positive electrode terminal 213 is provided on the short-side face 24, and the negative electrode terminal 212 is provided on the short-side face 23.

The electricity storage cell 211 further includes a cell gas discharge valve 218 that discharges gas inside the electricity storage cell 211. When the internal pressure of the electricity storage cell 211 increases, the cell gas discharge valve 218 discharges gas inside the electricity storage cell 211 to the outside of the electricity storage cell 211. The cell gas discharge valve 218 is provided on the short-side face 23 that is provided with the negative electrode terminal 212.

Referring to FIGS. 5 and 6, the arrangement of the electricity storage cells 211 inside the case 30 (refer to FIG. 2) will be described. In FIG. 5, constituent elements that are not visually recognizable due to the presence of the cooling plate 70 in plan view of the electricity storage apparatus 1 with an upper cover 31 (refer to FIG. 2) removed are indicated by dotted lines. In FIG. 5, the adhesive material 60 is not shown. In FIG. 6, the main bus bar 81 and sub bus bar 82 shown in FIG. 5 are not shown. As shown in FIGS. 5 and 6, the electricity storage cells 211 are disposed inside the case 30 such that the positive electrode terminals 213 and the negative electrode terminals 212 are alternately arranged in the first direction. Each inter-cell bus bar 217 is a conductor bar that can carry a large electric current. The material of each inter-cell bus bar 217 is, for example, copper. The positive electrode terminal 213 and the negative electrode terminal 212 that are adjacent to each other are electrically connected by a corresponding one of the inter-cell bus bars 217. Accordingly, the electricity storage cells 211 inside the case 30 (refer to FIG. 2) are electrically connected in series.

Referring to FIG. 2, the case 30 houses the electricity storage module 20, the first junction box 51, the second junction box 52, the adhesive material 60, the cooling plate 70, the main bus bar 81, the sub bus bar 82 (see FIG. 5), and the inter-cell bus bars 217 (refer to FIG. 5). The case 30 includes a lower case 32, and the upper cover 31. The case 30 is provided with the case gas discharge valve 40.

The lower case 32 is open upward. The lower case 32 has a bottom wall 321, and a peripheral wall 322. The peripheral wall 322 is erected from a peripheral edge portion of the bottom wall 321. The peripheral wall 322 has a substantially rectangular tubular shape. The peripheral wall 322 includes a side wall 323, a side wall 324, a side wall 325, and a side wall 326. The side wall 325 and the side wall 326 are spaced apart from each other in the first direction. The side wall 323 and the side wall 324 are spaced apart from each other in the perpendicular direction perpendicular to both the first direction and the up-down direction of the electricity storage apparatus 1. The side wall 325 and the side wall 326 are connected by the side wall 323 and the side wall 324.

The upper cover 31, together with the lower case 32, houses the electricity storage module 20, the first junction box 51, the second junction box 52, the adhesive material 60, the cooling plate 70, the main bus bar 81, the sub bus bar 82 (refer to FIG. 5), and the inter-cell bus bars 217 (refer to FIG. 5). A peripheral edge portion of the upper cover 31 is fixed to an upper end portion of the peripheral wall 322 with a bolt or the like.

Referring to FIG. 5, the electricity storage apparatus 1 has a space S1 between the electricity storage module 20 and the side wall 325. The electricity storage apparatus 1 also has a space S2 between the electricity storage module 20 and the side wall 323. The electricity storage apparatus 1 also has a space S3 between the electricity storage module 20 and the side wall 324.

The first junction box 51 and the second junction box 52 are disposed in the space S1. More specifically, the first junction box 51 is spaced apart from the electricity storage module 20 in the first direction. The first junction box 51 houses a positive electrode relay. The first junction box 51 is provided with a positive electrode bus bar connection terminal 91, and a positive electrode external terminal 93 (refer to FIG. 2). The positive electrode bus bar connection terminal 91 and the positive electrode external terminal 93 are connected through the positive electrode relay inside the first junction box 51. The first junction box 51 may further house a fuse.

The second junction box 52 is spaced apart from the electricity storage module 20 in the first direction. In addition, the second junction box 52 is adjacent to the first junction box 51 in a second direction. The second direction intersects both the first direction and the up-down direction of the electricity storage apparatus 1. In the present embodiment, the second direction is perpendicular to both the first direction and the up-down direction of the electricity storage apparatus 1. That is, in the present embodiment, the second direction coincides with the perpendicular direction. However, the second direction is not limited to the perpendicular direction. It is only required that the second direction intersect both the first direction and the up-down direction of the electricity storage apparatus 1. The second junction box 52 houses a negative electrode relay. The second junction box 52 is provided with a negative electrode bus bar connection terminal 92, and a negative electrode external terminal 94 (refer to FIG. 2). The negative electrode bus bar connection terminal 92 and the negative electrode external terminal 94 are connected through the negative electrode relay inside the second junction box 52. The second junction box 52 may further house a fuse.

The main bus bar 81 and the sub bus bar 82 are conductor bars that can carry a large electric current. The material of the main bus bar 81 and the sub bus bar 82 is, for example, copper. A connector 83 on one end of the main bus bar 81 is connected to the bus bar connection terminal 91. The other end of the main bus bar 81 is connected to the positive electrode terminal 213 of an electricity storage cell 211a. The electricity storage cell 211a is the outermost one of the electricity storage cells 211 in the first direction. That is, the electricity storage cell 211a is the farthest one of the electricity storage cells 211 from the first junction box 51 and the second junction box 52.

A connector 84 on one end of the sub bus bar 82 is connected to the bus bar connection terminal 92. The other end of the sub bus bar 82 is connected to the negative electrode terminal 212 of an electricity storage cell 211b. The electricity storage cell 211b is the innermost one of the electricity storage cells 211 in the first direction. That is, the electricity storage cell 211b is the closest one of the electricity storage cells 211 to the first junction box 51 and the second junction box 52. The main bus bar 81 and the sub bus bar 82 are coated with an insulator, such as resin, except the connected portions.

Referring to FIG. 6, the adhesive material 60 fixes the electricity storage module 20 and the cooling plate 70 to each other. The adhesive material 60 is disposed on an upper face 251 of the electricity storage module 20. The adhesive material 60 has thermal conductivity.

The cooling plate 70 is a device that cools the electricity storage cells 211 to adjust the temperature of the electricity storage cells 211. The cooling plate 70 is disposed on an upper face 65 of the adhesive material 60. As shown in FIGS. 2 and 5, the cooling plate 70 has a substantially flat plate shape. The cooling plate 70 is fixed to the electricity storage module 20 with the adhesive 60 material.

Referring to FIG. 2, the case gas discharge valve 40 discharges gas inside the case 30 to the outside of the case 30 when the internal pressure of the case 30 becomes higher than a predetermined pressure. The case gas discharge valve 40 is provided on the upper cover 31.

The position of the case gas discharge valve 40 will be described in more detail with reference to FIGS. 4 to 7. In FIG. 4, constituent elements that are visually recognizable when the upper cover 31 is removed from the electricity storage apparatus 1 are indicated by dotted lines. As shown in FIG. 4, in plan view of the case gas discharge valve 40 and the cooling plate 70, the case gas discharge valve 40 is disposed at a position away from the cooling plate 70. Referring to FIG. 5, the electricity storage apparatus 1 has the space S1 in which the first junction box 51 and the second junction box 52 are disposed. Referring to FIG. 7, the case gas discharge valve 40 is provided on the upper cover 31 over the space S1.

Referring to FIG. 5, the space S1 includes an inter-box region R1 located between the first junction box 51 and the second junction box 52. Referring to FIG. 7, the case gas discharge valve 40 is provided on the upper cover 31 over the inter-box region R1.

Referring to FIG. 5, gas discharged from each cell gas discharge valve 218 facing the space S2 passes through the space S2 and is discharged to the space $1. In addition, gas discharged from each cell gas discharge valve 218 facing the space S3 passes through the space S3 and is discharged to the space S1. Referring to FIG. 7, gas discharged to the space S1 is discharged to the outside of the case 30 through the case gas discharge valve 40 that is provided on the upper cover 31 over the space S1.

Referring to FIG. 6, the electricity storage apparatus 1 has a space S4 between the cooling plate 70 and the upper cover 31. Although not shown in FIG. 6, the main bus bar 81 shown in FIG. 5 passes through the space S4. The height of the first junction box 51 is lower than the height of the electricity storage cells 211. The height of the second junction box 52 (refer to FIG. 7) is lower than the height of the electricity storage cells 211. The height is the length in the up-down direction of the electricity storage apparatus 1 (refer to FIG. 2). The cooling plate 70 is disposed on the upper face 65 of the adhesive material 60 disposed on the upper face 251 of the electricity storage module 20 including the electricity storage cells 211. Thus, the distance between the upper cover 31 and the first junction box 51 is longer than the distance between the upper cover 31 and the cooling plate 70. In addition, the distance between the upper cover 31 and the second junction box 52 is longer than the distance between the upper cover 31 and the cooling plate 70. That is, a considerably wide space is provided under the case gas discharge valve 40. Thus, gases discharged from the electricity storage cells 211 are likely to gather under the case gas discharge valve 40. Thus, in the present embodiment, gas generated inside the case 30 can be easily discharged to the outside of the case 30.

It is only required that the case gas discharge valve 40 be provided on the upper cover 31 over the space S1, and the case gas discharge valve 40 does not have to be located over the inter-box region R1 (refer to FIG. 7).

In this manner, in the present embodiment, in plan view of the case gas discharge valve 40 and the cooling plate 70, the case gas discharge valve 40 is disposed at the position away from the cooling plate 70. If the case gas discharge valve 40 is provided on the upper cover 31 over the cooling plate 70, since the upper cover 31 and the cooling plate 70 are closed to each other, gases discharged from the electricity storage cells 211 are unlikely to gather under the case gas discharge valve 40. That is, when the case gas discharge valve 40 is provided on the upper cover 31 over the cooling plate 70, the cooling plate 70 obstructs the discharge of gas generated inside the case 30 to the outside of the case 30. However, in the present embodiment, in plan view of the case gas discharge valve 40 and the cooling plate 70, the case gas discharge valve 40 is disposed at the position away from the cooling plate 70. Thus, with the electricity storage apparatus 1 in the present embodiment, gas generated inside the case 30 can be easily discharged to the outside of the case 30.

In addition, in the present embodiment, the case gas discharge valve 40 is provided on the upper cover 31 over the space S1 in which the first junction box 51 and the second junction box 52 are disposed. Accordingly, a considerably wide space is provided under the case gas discharge valve 40. Thus, gases discharged from the electricity storage cells 211 are likely to gather under the case gas discharge valve 40. Thus, with the electricity storage apparatus 1 in the present embodiment, gas generated inside the case 30 can be easily discharged to the outside of the case 30.

In addition, in the present embodiment, the case gas discharge valve 40 is provided on the upper cover 31 over the inter-box region R1 located between the first junction box 51 and the second junction box 52. Accordingly, a considerably wide space is provided under the case gas discharge valve 40. Thus, gases discharged from the electricity storage cells 211 are likely to gather under the case gas discharge valve 40. Thus, with the electricity storage apparatus 1 in the present embodiment, gas generated inside the case 30 can be easily discharged to the outside of the case 30.

### Modification

In the above embodiment, the electricity storage apparatus 1 includes the first junction box 51, and the second junction box 52. However, the electricity storage apparatus 1 may include one junction box having the function of the first junction box 51 and the function of the second junction box 52. Also in this case, in plan view of the case gas discharge valve 40 and the cooling plate 70, the case gas discharge valve 40 is disposed at a position away from the cooling plate 70. More specifically, the junction box is disposed in the space S1, and the case gas discharge valve 40 is disposed on the upper cover 31 over the space S1.

The embodiment disclosed herein should be considered in all respects as illustrative and not restrictive. The scope of the present disclosure is defined by the claims rather than the foregoing description, and is intended to include all changes that fall within the meaning and scope equivalent to the claims.

What is claimed is:

1. An electricity storage apparatus comprising:
an electricity storage module;
an adhesive material disposed on an upper face of the electricity storage module;
a cooling plate disposed on an upper face of the adhesive material;
a case that houses the electricity storage module, the adhesive material, and the cooling plate; and
a case gas discharge valve provided on the case, wherein
the case gas discharge valve is disposed at a position away from the cooling plate in plan view of the case gas discharge valve and the cooling plate.

2. The electricity storage apparatus according to claim 1, further comprising:
a first junction box spaced apart from the electricity storage module in a first direction; and
a second junction box spaced apart from the electricity storage module in the first direction, the second junction box being adjacent to the first junction box in a second direction intersecting both the first direction and an up-down direction, wherein:
the case includes an upper cover, and a lower case;
the electricity storage apparatus has a space in which the first junction box and the second junction box are disposed; and
the case gas discharge valve is provided on the upper cover over the space.

3. The electricity storage apparatus according to claim 2, wherein:
the space includes an inter-box region located between the first junction box and the second junction box; and
the case gas discharge valve is provided over the inter-box region.
